(19) United States
(12) Patent Application Publication
(10) Pub. No.: US 2011/0148653 A1
(43) Pub. Date: Jun. 23, 2011

(54) DOOR BELL SYSTEM

(75) Inventors: Chen-Yi Lin, Hsinchu City (TW); Tzu-An Lin, Hsinchu City (TW)

(73) Assignee: CHEN-YI LIN, Hsinchu City (TW)

(21) Appl. No.: 12/703,797

(22) Filed: Feb. 11, 2010

(30) Foreign Application Priority Data
Dec. 21, 2009 (TW) 098223874

(51) Int. Cl. G08B 3/00; G06F 3/041; G06F 3/033

(52) U.S. Cl. 340/691.6; 345/173; 345/163; 340/692

(57) ABSTRACT

The present invention illustrates a touch input and display device of door bell systems to replace conventional bells, which only have push buttons. Having a variety of input options, the door bell systems in the present invention can produce customized products, such as visitors ringing the bell, door opened automatically, transmitting calls, and message bulletin board etc.

### FIELD OF THE INVENTION

The present invention relates to the door bell system. More specifically, the present invention relates to use a touch screen in the door bell system to replace conventional bells, which only have push buttons. Thus, the door bell system in the present invention can be customized to meet the customers' needs.

### DESCRIPTION OF THE RELATED ART

In spite of many door bell systems available on the market, they all use conventional push buttons to trigger rings, and perform functions other than touch screen does in order to enhance the bell systems.

### SUMMARY OF THE INVENTION

The present invention utilizes a touch screen as the display unit and input unit to replace push buttons as used in conventional bells, which trigger rings. Having a variety of input options, the bell systems in the present invention can produce customized products. Users of the bell systems can display the desired functions on the touch screen to fulfill customers' needs, such as functions of allowing visitors to ring the bell, automatically opening the door, transmitting calls, and the message bulletin board etc.

The door bell system in the present invention comprises a touch screen, a memory, at least one intercom, at least one sound producing device, and a microprocessor. The touch screen is used as the display and input unit, and the memory stores procedures and data. The intercoms can be used for at least one host to communicate with at least one person outside. Also, the sound producing device makes sounds. Besides, the microprocessor is connected to the touch screen, the memory, the intercom, and the sound producing device for processing data, and then the microprocessor transforms the data into the corresponding output signal.

The touch screen will provide the person outside the house with the corresponding function options. After choosing a function option by the person outside the house, the data corresponding to the function option will be transmitted to the microprocessor. Then the microprocessor controls the sound producing device to make sounds or opens the intercom based on the content of the function option. Thus, the host of the house can communicate with the person outside.

Additionally, the door bell system in the present invention may comprise other peripherals and corresponding control circuits; also, the microprocessor may output control signal to control the peripherals. The input function options and the layout of the touch screen may be designed by the user, and be displayed on the touch screen. The function options and layout of the screen are established from the touch screen or from the control circuits. The touch screen may be replaced by a liquid crystal display and a mouse, and further the start screen of the touch screen may be installed by user's preference. Lastly, a shield may be disposed on the upper portion, the left hand side, the front portion, or the right hand side of the touch screen in order to shield against the wind and rain.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a block diagram in accordance with the door bell systems in the present invention.

### DETAILED DESCRIPTION OF THE PREFERRED EMBODIMENTS

Exemplary embodiments of the present invention are described herein in the context of the door bell system.

Those of ordinary skilled in the art will realize that the following detailed description of the exemplary embodiment is illustrative only and is not intended to be in any way limiting. Other embodiments will readily suggest themselves to such skilled persons having the benefit of this disclosure. Reference will now be made in detail to implementations of the exemplary embodiment as illustrated in the accompanying drawings. The same reference indicators will be used throughout the drawings and the following detailed description to refer to the same or like parts.

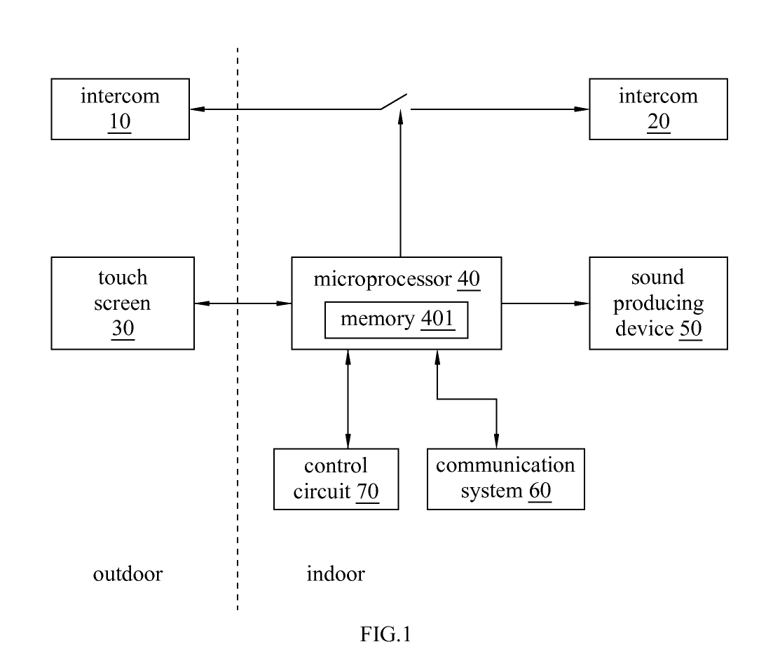

Please refer to FIG. 1, which illustrates a block diagram in accordance with the door bell system in the present invention. As shown, the door bell system in the present invention comprises a touch screen 30, a memory 401, intercoms 10, 20, a sound producing device 50, and a microprocessor 40. The touch screen 30 thereof is used as the display and input unit of the bell system and the memory 401 stores procedures and data. Besides, the intercoms 10, 20 may be used by the host of the houses to communicate with people outside the house, and the sound producing device 50 makes sounds. Also, the microprocessor 40 is connected to a touch screen 30, a memory 401, intercoms 10, 20, and the sound producing device 50 to process data from the touch screen 30 and to transform the data transmitted from touch screen 30 to a corresponding output signal.

The touch screen 30 may provide at least one people outside with at least one corresponding function options. After selecting the option by the people outside, the data corresponding to the function option is transmitted to the microprocessor 40, and then the microprocessor 40 controls the sound producing device 50 to make sounds or to start up intercoms 10, 20 based on content of the function options for the communication of both parties. The function options and layout of the screen are established from the touch screen or from the control circuits.

Additionally, the door bell system in the present invention may further comprise at least one peripheral device, the corresponding control circuits 70, and at least one control signal outputs by the microprocessor 40 to control the peripheral devices. Furthermore, the input function options and the touch screen 30 may be designed by the user of the door bell system and installed on the touch screen 30. The touch screen 30 may be replaced by a liquid crystal display and a mouse, and the startup screen may be installed according to user's preference. Lastly, a shield may be disposed on the upper portion, the left hand side, the front portion, or the right hand side of the touch screen 30 to shield against the wind and the rain.

The touch screen 30 in the present invention is the display and input unit, wherein after selecting an option by the people outside the house, data corresponding to the input function options is transmitted to the microprocessor 40, the microprocessor 40 then outputs the necessary control signal based on the content of the options. For example, microprocessor 40 may control the sound producing device to make sounds, control the wired or wireless transmission communication system 60, control an electronic 70 to unlock, or control the peripheral devices etc.

The touch screen 30 in the present invention provides the people outside with corresponding messages options. After selecting an option by the people outside the house, the data corresponding to the input function options is transmitted to the microprocessor 40; the microprocessor 40 then reacts accordingly based on the option content. For example, microprocessor 40 may control the sound producing device to make sounds, to input other information by the people outside, to start up the intercoms 10, 20, to start up the communication system 60 by the wired or by wireless calls, to start up the control circuit 70 for opening the door, or other actions etc. The function options and layout of the screen are established from the touch screen or from the control circuits.

Following is one embodiment of the present invention. First the touch screen 30 may comprise message bulletin board, such as address, input options and using pictures as screen background. People outside the house need to choose one of the present options, e.g. the touch screen 30 presents message bulletin board and two options: “Family” and “Visitor.” The method comprises the following steps:

Step 1: The touch screen 30 presents two options: “Family” and “Visitor.”
(1) If “Family” has been chosen, go to Step 2;
(2) If “Visitor” has been chosen, go to Step 4;
   Step 2: The touch screen 30 presents two options: “Input password” and “Enter Intercommunication mode.”
(1) If “Input password” has been chosen, the touch screen 30 presents a keyboard for people outside to input password;
   (A) If the input password has been verified as correct, go to Step 3;
   (B) If the input password has been verified as incorrect, go to Step 1;
(2) If “Enter Intercommunication mode” has been chosen, microprocessor 40 controls sound producing device 50 to produce sounds, and performs functions of intercoms 10, 20. After intercommunication, go to Step 1;
   Step 3: The touch screen 30 presents three options: “Enter Intercommunication mode”, “Enter Calling mode”, and “Enter Door-opened mode.”
(1) If “Enter Intercommunication mode” has been chosen, the microprocessor 40 controls sound producing device 50 to make sounds and performs functions of intercoms 10, 20. After the intercommunication, go to Step 1;
(2) If “Enter Calling mode” has been chosen, the touch screen 30 presents a keyboard for the people outside to input a telephone number, and then the microprocessor 40 dials the input telephone number. After the call ending, go to Step 1;
(3) If “Enter Door-opened mode” has been chosen, the touch screen 30 presents a keyboard for the people outside to input password:
   (A) If the password is correct, open the door/gate and go to Step 1;
   (B) If the password is incorrect, go to Step 1;
      Step 4: The microprocessor 40 controls sound producing device 50 to make sounds and performs functions of intercoms 10, 20. After the intercommunication, go to Step 1.

Following is another embodiment of the present invention. People outside an apartment or a community need to select the apartment number or the house number first. Then, the touch screen 30 may comprise message bulletin board, such as address, input options and using pictures as screen background. Next, the people outside need to choose one of the present options, e.g. the touch screen 30 presents message bulletin board and two options: “Family” and “Visitor.” The method comprises the following steps:

Step 1: The touch screen 30 presents two options: “Family” and “Visitor.”
(3) If “Family” has been chosen, go to Step 2;
(4) If “Visitor” has been chosen, go to Step 4;
   Step 2: The touch screen 30 presents two options: “Input password” and “Enter Intercommunication mode.”
(1) If “Input password” has been chosen, the touch screen 30 presents a keyboard for people outside to input password;
   (A) If the input password has been verified as correct, go to Step 3;
   (B) If the input password has been verified as incorrect, go to Step 1;
(2) If “Enter Intercommunication mode” has been chosen, microprocessor 40 controls sound producing device 50 to produce sounds, and performs functions of intercoms 10, 20. After the intercommunication, go to Step 1;
   Step 3: The touch screen 30 presents three options: “Enter Intercommunication mode”, “Enter Calling mode”, and “Enter Door-opened mode.”
(1) If “Enter Intercommunication mode” has been chosen, the microprocessor 40 controls sound producing device 50 to make sounds and performs functions of intercoms 10, 20. After the intercommunication, go to Step 1;
(2) If “Enter Calling mode” has been chosen, the touch screen 30 presents a keyboard for the people outside to input a telephone number, and then the microprocessor 40 dials the input telephone number. After the call ending, go to Step 1;
(3) If “Enter Door-opened mode” has been chosen, the touch screen 30 presents a keyboard for the people outside to input password:
   (A) If the password is correct, open the door/gate and go to Step 1;
   (B) If the password is incorrect, go to Step 1;
      Step 4: The microprocessor 40 controls sound producing device 50 to make sounds and performs functions of intercoms 10, 20. After the intercommunication, go to Step 1.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment of the present invention.

What is claimed is:

1. A door bell system, comprising:
a touch screen utilized as the input and display device;
a memory storing procedures and data;
at least one intercom for communicating;
at least one sound producing device producing sounds; and
a microprocessor connected to the touch screen, the memory, and at least one sound producing device; the microprocessor processing at least one data from the touch screen and transforming at least one data into at least one corresponding output signal;
wherein the touch screen provides at least one person outside with at least one function option, and after the selection of at least one function option, data corresponding to the function option is transmitted to the microprocessor; the microprocessor controls the sound producing device to produce sounds.

2. The door bell system as claimed in claim 1, further comprising at least one peripheral device, at least one corresponding control circuit, and at least one control signal output by the microprocessor to control the at least one peripheral device.

3. The door bell system as claimed in claim 1, wherein the layout on the touch screen and the at least one function option are designed by the user.

4. The door bell system as claimed in claim 1, wherein the layout on the touch screen and the at least one function option are disposed on the touch screen.

5. The door bell system as claimed in claim 1, wherein the startup screen of the touch screen is designed according to user's preference.

6. The door bell system as claimed in claim 2, wherein the function option and layout of the screen are established from the touch screen or from the corresponding control circuit.

7. The door bell system as claimed in claim 1, wherein a shield is disposed on the upper portion, the left hand side, the front portion, or the right hand side of the touch screen to shield against the wind and the rain.

8. A door bell system, comprising:
a liquid crystal display and a mouse utilized as the display and input device;
a memory storing procedures and data;
at least one intercom for communicating;
at least one sound producing device producing sounds; and
a microprocessor connected to the liquid crystal display, the mouse, the memory, and at least one sound producing device; the microprocessor processing at least one data from the mouse and transforming at least one data into at least one corresponding output signal;
wherein the liquid crystal display provides at least one person outside with at least one function option, and after the selection of at least one function option, data corresponding to the function option is transmitted to the microprocessor; the microprocessor controls the sound producing device to produce sounds.

9. The door bell system as claimed in claim 8, further comprising at least one peripheral device, at least one corresponding control circuit, and at least one control signal output by the microprocessor to control the at least one peripheral device.

10. The door bell system as claimed in claim 8, wherein the layout on the liquid crystal display and the at least one function option are designed by the user.

11. The door bell system as claimed in claim 8, wherein the layout on the liquid crystal display and the at least one function option are disposed on the touch screen.

12. The door bell system as claimed in claim 8, wherein the startup screen of the liquid crystal display is designed according to user's preference.

13. The door bell system as claimed in claim 9, wherein the function option and layout of the liquid crystal display are established from the liquid crystal display and the mouse or from the corresponding control circuit.

14. The door bell system as claimed in claim 8, wherein a shield is disposed on the upper portion, the left hand side, the front portion, or the right hand side of the touch screen to shield against the wind and the rain.
